(19) United States
(12) Patent Application Publication
(10) Pub. No.: US 2026/0074444 A1
(43) Pub. Date: Mar. 12, 2026

(54) TOOL DRIVEN WEDGE CONNECTORS

(71) Applicant: Hubbell Incorporated, Shelton, CT (US)

(72) Inventors: Connor Owen Douglas Buckley, Manchester, NH (US); Bradley Steven Elliott, Epping, NH (US); Brian Royal Ellis, Dover, NH (US)

(21) Appl. No.: 19/320,436

(22) Filed: Sep. 5, 2025

Related U.S. Application Data
(60) Provisional application No. 63/691,578, filed on Sep. 6, 2024.

(51) Int. Cl. H01R 4/50

(52) U.S. Cl. CPC H01R 4/5083

(57) ABSTRACT

Hammer driven connector assemblies where a pressure member is attached to a connector body by an interference fit. The connector assemblies are used to splice or join electrical conductors within the connector body. The pressure member applies a compressive force to two or more electrical conductors when the pressure member is secured or attached to the connector body by an interference fit.

### CROSS-REFERENCE TO RELATED APPLICATIONS

This application is based on and claims benefit from co-pending U.S. Provisional Patent Application No. 63/691,578 filed on Sep. 6, 2024 entitled “Hammer Driven Wedge Connector” the contents of which are incorporated herein in its entirety by reference.

### FIELD

The present disclosure relates to connectors for electrical conductors that provide a permanent electrical connection between two or more electrical conductors. More particularly, the present disclosure relates to hammer driven splice connectors that provide a permanent electrical connection between two or more electrical conductors.

### DESCRIPTION OF THE RELATED ART

Compression connectors have been used to irreversibly connect or join electrical conductors together. With compression connectors, to irreversibly connect or join electrical conductors together, the compression connector is placed in a standard crimping tool, such as a hydraulic 12-ton or 15-ton hand-held power tool, that has dies in a working head of the tool. When the tool is activated, the dies engage the compression connector and compress the connector to irreversibly connect or join electrical conductors together. An example of a hydraulic power tool is the 15-Ton PATRIOT® PAT46 crimper, manufactured by Burndy, LLC. Such hydraulic power tools are expensive so that users often justify the purchase of such tools when there are many crimps to be made.

The present disclosure provides a more economical alternative to irreversibly connect large size electrical conductors together where there is a lower number of crimps to be made.

### SUMMARY OF THE DISCLOSURE

The present disclosure provides embodiments of electrical connector assemblies. In an exemplary embodiment, an electrical connector assembly includes a connector body, a pressure member and at least one fastener. The connector body includes a central portion, a first end portion and a second end portion. The central portion includes at least one fastener bore. The first end portion includes an inner wall configured to receive a first conductor and a free end. The second end portion includes an inner wall configured to receive a second conductor and a free end. The free end of the first end portion and the free end of the second end portion are spaced apart forming an opening in the connector body. The pressure member includes a body with at least one fastener bore extending therethrough. The pressure member also includes a first pressure boss and a second pressure boss. The first pressure boss is configured to contact the first conductor positioned within the first end portion when the pressure member is installed in the connector body opening. The second pressure boss is configured to contact the second conductor positioned within the second end portion when the pressure member is installed in the connector body opening. The pressure member body having a width along an upper portion of the body that is larger than the space between the free end of the first end portion and the free end of the second end portion. The at least one fastener is configured to fit within the at least one fastener bore of the central portion by an interference fit and to fit within the at least one fastener bore in the pressure member by an interference fit to secure the pressure member to the connector body.

In another exemplary embodiment, the electrical connector assembly includes a connector body and at least one pressure member. The connector body includes a plurality of conductor apertures and at least one pressure member opening. Each of the plurality of conductor apertures extend through the connector body, and the at least one pressure member opening extends from an exterior of the connector body into the connector body so that the at least one pressure member opening intersects the plurality of conductor apertures. The at least one pressure member is configured to fit within the at least one pressure member opening by an interference fit. The pressure member includes a first contact surface and a second contact surface. The first contact surface is configured to contact a first conductor positioned within the first conductor aperture when the at least one pressure member is installed in the at least one pressure member opening. The second contact surface is configured to contact a second conductor positioned within the second conductor aperture when the at least one pressure member is installed in the at least one pressure member opening.

In another exemplary embodiment, the electrical connector assembly includes a connector body, a pressure member and at least one fastener. The connector body has a central portion that includes at least one fastener bore positioned between a first end portion, e.g., a C-shaped member, and a second end portion, e.g., a C-shaped member. The first end portion of the connector body includes an inner wall configured to receive a first conductor and a free end, and the second end portion of the connector body includes an inner wall configured to receive a second conductor and a free end. The free end of the first and second end portions are spaced apart to form an opening in the connector body having a first width. The first width is configured to permit the pressure member to pass through the connector body opening. The pressure member includes a body with at least one fastener bore extending through the body. In some embodiments, the central portion of the connector body includes a raised edge and the pressure member body includes an alignment notch configured to receive the raised edge. The raised edge and notch facilitate aligning the pressure member body within the connector body. Preferably, the pressure member body has a width along at least a portion of the body that is larger than the first width of the connector body opening. The pressure member body also includes a first pressure boss and a second pressure boss. The first pressure boss is configured to contact and hold the first conductor within the first end portion of the connector body when the pressure member is installed in the connector body. The second pressure boss is configured to contact and hold the second conductor within the second end portion of the connector body when the pressure member is installed in the connector body. In some embodiments, when the first pressure boss contacts and holds the first conductor within the first end portion, the first pressure boss deforms the first conductor, and when the second pressure boss contacts and holds the second conductor within the second end portion, the second pressure boss deforms the second conductor. The at least one fastener is configured to fit within the at least one fastener bore of the central portion of the connector body and the at least one fastener bore in the pressure member body and is secured thereto by an interference fit. The at least one fastener bore may be a circular bore and the at least one fastener may be a cylindrical member such that the cylindrical member fits within the fastener bore with the interference fit. However, the present disclosure contemplates different shapes of the at least one fastener bore and the at least one fastener, including square, oval and elliptical shapes.

In some embodiments, the pressure member may include a first locking boss and a second locking boss. In such embodiments, the first and second locking bosses may extend from the pressure member so as to increase a width of at least a portion of the pressure member so that the width of the at least a portion of the pressure member is greater than the first width of the opening in the connector body. When the locking bosses contact the free ends of the first and second end portions, the first and second end portions of the connector body flex so as to increase the opening in the connector body to a second width, such that the second width is great than the first width so that the pressure member can pass through the connector body opening into the connector body. And, when the locking bosses no longer contact the free ends of the first and second end portions, the opening in the connector body returns, e.g., springs back or otherwise automatically returns, to the first width. In some embodiments, the first and second locking bosses include one or more camming surfaces that contact the respective free ends of the first and second end portions of the connector body when the pressure member is installed in the connector body. When the camming surfaces contact the free ends of the first and second end portions, the first and second end portions of the connector body flex so as to increase the opening in the connector body to a second width, such that the second width is great than the first width so that the pressure member can pass through the connector body opening into the connector body. And, when the camming surfaces no longer contact the free ends of the first and second end portions, the opening in the connector body returns, e.g., springs back or otherwise automatically returns, to the first width.

In another exemplary embodiment, the electrical connector assembly includes a connector body, a pressure member and a fastener. The connector body includes a central portion having a fastener bore. The central portion is positioned between a first end portion and a second end portion of the connector body. The first end portion includes a C-shaped inner wall that is configured to receive a first conductor and a free end. Similarly, the second end portion includes a C-shaped inner wall that is configured to receive a second conductor and a free end. The free end of the first and second end portions are spaced apart to form an opening having a first width in the connector body. The pressure member includes a body having a fastener bore that extends through the pressure member body. Preferably, the fastener bore is positioned in the pressure member body to align with the fastener bore in the central portion when the pressure member is installed in the connector body. In some embodiments, the central portion of the connector body includes a raised edge and the pressure member body includes an alignment notch configured to receive the raised edge. The raised edge and notch facilitate aligning the pressure member body with the connector body when installed. Preferably, at least a portion of the pressure member body has a width that is larger than the first width of the connector body opening. The larger width of the pressure member body may be, for example, at an upper portion of the pressure member body. The pressure member body may also include a first pressure boss and a second pressure boss. The first pressure boss is configured to contact and hold the first conductor within the first end portion of the connector body when the pressure member is installed in the connector body. Similarly, the second pressure boss is configured to contact and hold the second conductor within the second end portion of the connector body when the pressure member is installed in the connector body. In some embodiments, when the first pressure boss contacts and holds the first conductor within the first end portion, the first pressure boss deforms the first conductor. Similarly, when the second pressure boss contacts and holds the second conductor within the second end portion, the second pressure boss deforms the second conductor. In some embodiments, the pressure member includes a first locking boss and a second locking boss. The first and second locking bosses extend from the pressure member, e.g., an upper portion of the pressure member, so as to increase a width of at least a portion of the pressure member. Preferably, the width of the at least a portion of the pressure member is greater than the first width of the opening in the connector body. When the locking bosses contact the free ends of the first and second end portions, the first and second end portions of the connector body flex so as to increase the opening in the connector body to a second width. And, when the locking bosses no longer contact the free ends of the first and second end portions, the opening in the connector body returns, e.g., springs back or automatically returns, to the first width. In some embodiments, the first and second locking bosses include camming surfaces that contact the free end of the first end portion of the connector body when the pressure member is installed in the connector body. When the camming surfaces contact the free ends of the first and second end portions, the first and second end portions of the connector body flex so as to increase the opening in the connector body to a second width. And, when the camming surfaces no longer contact the free ends of the first and second end portions, the opening in the connector body returns, e.g., springs back or automatically returns, to the first width. In some embodiments, the fastener is configured to fit within the fastener bore of the central portion and the fastener bore in the pressure member by an interference fit. In some embodiments, the fastener bore is a circular bore and the fastener is a cylindrical member such that the cylindrical member fits within the fastener bore with the interference fit.

In another exemplary embodiment, the electrical connector assembly includes a connector body and at least one a pressure member. The connector body includes first and second conductor apertures and at least one pressure member opening. The first and second conductor apertures extend through the connector body and are configured to receive an electrical conductor or wire. The at least one pressure member opening extends from an exterior of the connector body into the connector body so that the at least one pressure member opening at least partially intersects the first and second conductor apertures. The at least one pressure member is configured to fit within the at least one pressure member opening by an interference fit. The at least one pressure member includes a first contact surface and a second contact surface. In some embodiments, the at least one pressure member may include an impacting surface, that may be, for example, a substantially flat surface. The first contact surface is configured to contact and hold a first conductor within the first conductor aperture when the at least one pressure member is installed in the at least one pressure member opening. Similarly, the second contact surface is configured to contact and hold a second conductor within the second conductor aperture when the at least one pressure member is installed in the at least one pressure member opening. In some embodiments, when the first contact surface contacts and holds the first conductor within the first conductor aperture, the first contact surface applies a force or pressure on the first conductor such that the first conductor is wedged against an inner wall of the first conductor aperture. Similarly, when the second contact surface contacts and holds the second conductor within the second conductor aperture, the second contact surface applies a force or pressure on the second conductor such that the second conductor is wedged against an inner wall of the second conductor aperture. In some embodiments, when the first contact surface contacts and holds the first conductor within the first conductor aperture, the first contact surface applies a force or pressure on the first conductor deforming the first conductor so that the first conductor is wedged against an inner wall of the first conductor aperture. Similarly, when the second contact surface contacts and holds the second conductor within the second conductor aperture, the second contact surface applies a force or pressure on the second conductor deforming the second conductor so that the second conductor is wedged against an inner wall of the second conductor aperture.

### BRIEF DESCRIPTION OF THE DRAWINGS

To further clarify the above and other advantages and features of the subject matter of this patent specification, specific examples of embodiments thereof are illustrated in the appended drawings. It should be appreciated that these drawings depict only exemplary embodiments and are therefore not to be considered limiting of the scope of this patent specification or the appended claims. The subject matter hereof will be described and explained with additional specificity and detail through the accompanying drawings in which:

FIG. 1 is a top perspective view of an exemplary embodiment of a connector assembly according to the present disclosure, illustrating a connector body, a pressure member and a pin that couples the pressure member to the connector body;

FIG. 2 is a bottom perspective view of the connector assembly of FIG. 1;

FIG. 3 is an exploded perspective view of the connector assembly of FIG. 1;

FIG. 4 is a top perspective view of an exemplary embodiment of the connector body of the connector assembly of FIG. 1, illustrating a fastener bore in the connector body;

FIG. 5 is a bottom perspective view of the connector body of the connector assembly of FIG. 4;

FIG. 6 is a side elevation view of the connector body of FIG. 4;

FIG. 7 is a first side perspective view of an exemplary embodiment of the fastener of the connector assembly of FIG. 1;

FIG. 8 is a top perspective view of an exemplary embodiment of the pressure member of FIG. 1;

FIG. 9 is a bottom perspective view of an exemplary embodiment of the pressure member of FIG. 8;

FIG. 10 is a side elevation view of the pressure member of FIG. 8;

FIG. 11 is a top plan view of the pressure member of FIG. 8, illustrating a fastener bore in the pressure member;

FIG. 12 is a bottom plan view of the pressure member of FIG. 8;

FIG. 13 is an exploded side perspective view of the connector assembly of FIG. 1, illustrating electrical conductors inserted into the connector body, and illustrating the fastener attached to the pressure member with the pressure member and fastener staged for hammered into the connector body until the pressure member is in a clamping position clamping the electrical conductors to the connector body;

FIG. 14 is a perspective view of the connector assembly of FIG. 13, illustrating the electrical conductors secured to the connector body using the pressure member and fastener;

FIG. 15 is a side elevation view of the electrical conductors and connector assembly of FIG. 13;

FIG. 16A is a side elevation view of the electrical conductors and connector assembly of FIG. 15, illustrating the pressure member resting on the connector body and ready for hammering into the connector body;

FIG. 16B is a side elevation view of the electrical conductors and connector assembly of FIG. 16A after the pressure member is hammered into the connector body and illustrating indents in the conductors created by the pressure member;

FIG. 17 is a top perspective view of another exemplary embodiment of a connector assembly according to the present disclosure, illustrating a connector body and a pressure member;

FIG. 18 is a bottom perspective view of the connector assembly of FIG. 17;

FIG. 19 is an exploded perspective view of the connector assembly of FIG. 17;

FIG. 20 is a side elevation view of the connector body of FIG. 17;

FIG. 21 is a top side perspective view of an exemplary embodiment of the pressure member of the connector assembly of FIG. 17;

FIG. 22 is a bottom side perspective view of an exemplary embodiment of the pressure member of FIG. 21;

FIG. 23 is a side elevation view of the pressure member of FIG. 21;

FIG. 24 is an end elevation view of the pressure member of FIG. 21;

FIG. 25 is an exploded end perspective view of the connector assembly of FIG. 17, illustrating electrical conductors staged for insertion into the connector body and the pressure member staged for hammering into the connector body until the pressure member is in a clamping position clamping the electrical conductors to the connector body;

FIG. 26 is an end elevation view of the connector assembly of FIG. 25, illustrating the electrical conductors and the pressure member inserted into the connector body and staged for hammering into the connector body until the pressure member is in a clamping position clamping the electrical conductors to the connector body;

FIG. 27 is an end elevation view in partial cut-away of the connector assembly of FIG. 26, illustrating the pressing member hammered into the connector body and the pressing the electrical conductors to the connector body; and

FIG. 28 is a perspective view of the connector assembly of FIG. 27.

### DETAILED DESCRIPTION

Detailed descriptions of exemplary embodiments of electrical conductor connectors are provided. While several embodiments are described, the new subject matter described in this patent specification is not limited to any one embodiment or combination of embodiments described herein, but instead encompasses numerous alternatives, modifications, and equivalents. In addition, while numerous specific details are set forth in the following description to provide a thorough understanding, some embodiments can be practiced without some or all such details. Moreover, for the purpose of clarity, certain technical material that is known in the related art has not been described in detail in order to avoid unnecessarily obscuring the new subject matter described herein. It should be clear that individual features of one or several of the specific embodiments described herein can be used in combination with features of other described embodiments or with other features. Further, like reference numbers and designations in the various drawings indicate like elements.

The electrical conductor connector assemblies contemplated by the present disclosure are interference fit type connector assemblies where a fastener, e.g., a pin, and pressure member, e.g., a wedge, are attached to a connector body by an interference fit, e.g., a friction fit or a press fit connection. The electrical conductor connector assemblies according to the present disclosure are used to secure electrical conductors within the connector body. The pressure member applies a compressive force to two or more electrical conductors when the pressure member is secured or attached to the connector body by an interference fit. In some embodiments, the interference fit may be achieved by hammering or pressing the fastener at least partially into the pressure member and by hammering or pressing the fastener at least partially into the connector body. In some embodiments, the interference fit may be achieved by hammering or pressing the pressure member directly into the connector body. Locking features may be included to help facilitate the irreversible connection between the connector body, the pressure member and the two or more conductors. In some embodiments, when the pressure member is driven, e.g., hammered or pressed, into the connector body to a certain point, the locking features engage with the connector body to help facilitate the irreversible connection between the connector body, the pressure member and the two or more conductors. In some embodiments, the locking feature may be part of the pressure member such that the pressure member profile includes a locking feature that when installed interacts with the connector body to lock the pressure member to the connector body. In some embodiments, the pin and pressure member design could have a locking feature where the pressure member has one or more ribs, a wings-like structure and/or an extruded boss that causes a portion of the pressure member to be wider than an opening in connector body, so that when the pressure member is attached or secured to the connector by the interference fit connection, the one or more ribs, a wings-like structure and/or an extruded boss block the pressure member from being removed from the connector body.

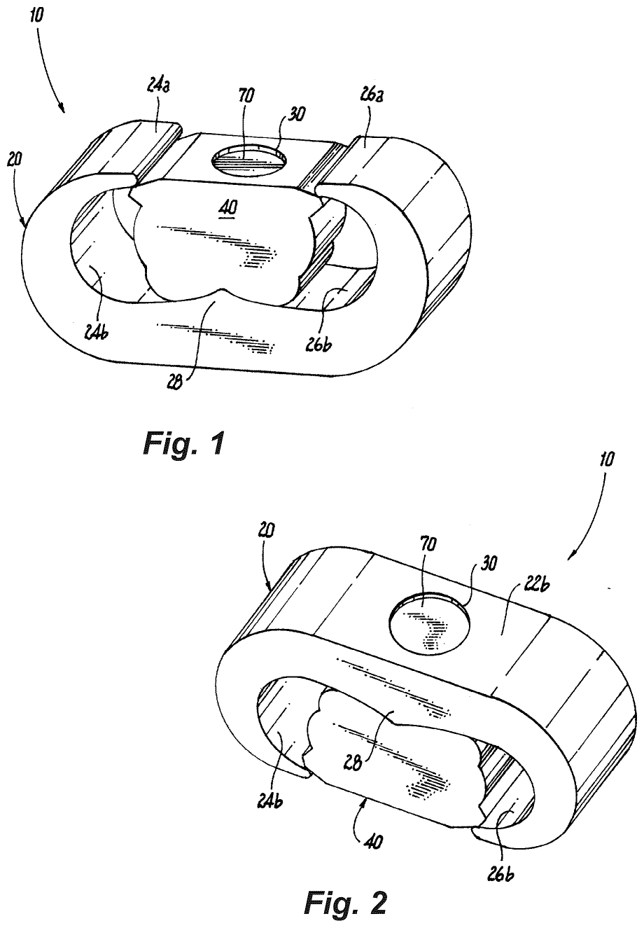

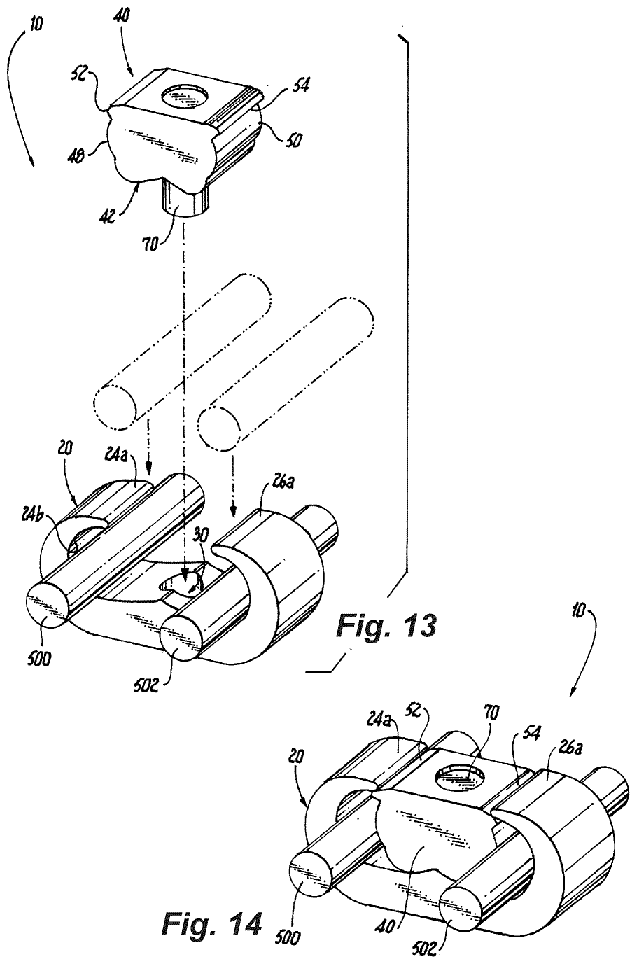

Referring to FIGS. 1-3, an exemplary embodiment of an electrical conductor connector assembly according to the present disclosure is shown. For ease of description, the electrical conductor connector assembly may also be referred to herein as the “connector” in the singular and the “connectors” in the plural. In this exemplary embodiment, connector 10 includes a connector body 20, a pressure member 40 and one or more fasteners 70. The connector body 20 may also be referred to herein as the “body.” The connector 10 may be configured and dimensioned to electrically connect two or more electrical conductors 500 and 502, seen in FIG. 13, such that the two or more electrical conductors 500 and 502 are in electrical communication. The electrical conductors 500 and 502 may also be referred to herein as the “conductors” in the plural and the “conductor” in the singular. The size of the conductors 500 and 502 may vary depending upon the intended purpose of the conductors and requirements set forth in industry standards and/or regulations. The two or more conductors 500 and 502 may be the same size or the conductors may be different size conductors. To illustrate, in one embodiment the conductors 500 and 502 may be the same size, such as a #6 AWG conductor, or in another embodiment, the conductors 500 and 502 may be the different in size, such as a #6 AWG conductor 500 and a #2 AWG conductor 502.

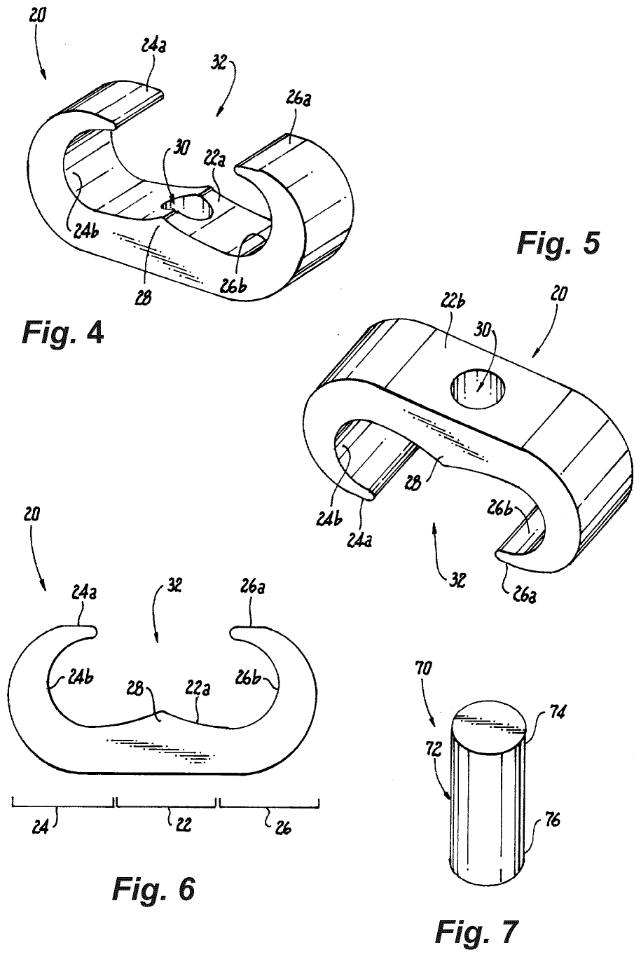

Referring now to FIGS. 4-6, the connector body 20 includes a central portion 22, a first end portion 24 and a second end portion 26, seen in FIG. 6. The central portion 22, a first end portion 24 and a second end portion 26 are preferably solid structures that are preferably monolithically formed into a unitary body. The central portion 22 has an interior wall 22a that may include a raised edge 28 located substantially at a center of the central portion 22. The raised edge 28 helps direct the conductors 500 and 502 substantially within first end portion 24 and the second end portion 26 respectively. The raised edge 28 may also contact with the pressure member 40, seen in FIG. 1, to maintain the position of the pressure member 40 within the connector body 20. The central portion 22 of the connector body 20 also includes a fastener bore, opening or aperture 30 that is configured and dimensioned to receive at least a portion of the fastener 70 so that the fastener 70 can secure the pressure member 40 the connector body 20 with an interference fit, e.g., a friction fit or press fit connection. For ease of description, the fastener bore, opening or aperture 30 may also be referred to herein as the “fastener bore 30” or the “bore 30.” The fastener bore 30 may have a first diameter at the beginning of the fastener bore 30, which is at the exterior of the inner wall 22a of the central portion 22, and a second diameter at the end of the fastener bore 30, which is at the exterior wall 22b of the central portion 22. In some exemplary embodiments, the first and second diameters of the fastener bore 30 may be the same, such that the diameter of the fastener bore 30 is constant. In other embodiments, the first and second diameters of the fastener bore 30 may be different. For example, the first diameter may be the widest at the beginning of the fastener bore 30 and the second diameter may be the narrowest at the end of the fastener bore 30, and the first diameter may gradually decrease from the beginning to the second diameter at the end of the fastener bore 30.

The first end portion 24 extends from one end of the central portion 22 and includes one or more inner walls 24b. The second end portion 26 extends from the other end of the central portion 22 and includes one or more inner walls 26b. Preferably, the one or more inner walls 24b of the first end portion 24 and the one or more inner walls 26b of the second end portion 26 are configured and dimensioned to receive a conductor 500 or 502. In the exemplary embodiment shown, the first end portion 24 is a C-shaped structure that includes a free end 24a and the one or more inner walls 24b are arcuate in shape. Similarly, the second end portion 26 is a C-shaped structure that includes a free end 26a and the one or more inner walls 26b are arcuate in shape. The free end 24a of first end portion 24 and the free end 26a of the second end portion 26 are spaced apart to form a conductor opening, aperture or bore 32 through which the conductors 500 and 502, the pressure member 40 and the fastener 70 can pass into the connector body 20. For ease of description, the conductor opening, aperture or bore 32 may also be referred to herein as the “conductor opening 32” or the “opening 32.” In this configuration, the first end portion 24 and the second end portion 26 form opposing C-shaped wire receiving members used to electrically connect two or more electrical conductors 500 and 502 together. The connector body 20 is preferably made of an electrically conductive material, such as an electrically conductive metal. Non-limiting examples of electrically conductive metals include copper, aluminum, aluminum alloys, stainless steel, brass. However, the present disclosure contemplates that other electrically conductive materials may be used to fabricate the connector body 20. Non-limiting examples of other electrically conductive materials include graphite and conductive polymers.

Referring to FIG. 7, in the exemplary embodiment shown, the fastener 70 is a pin configured to fit snuggly within the fastener bore 30 so that there is little to no gap between the fastener 70 and a wall of the fastener bore 30. The purpose of the snug fit is so that fastener 70 can secure the pressure member 40 within the opening 32 in the connector body 20 with an interference fit connection, e.g., a friction fit or a press fit connection. The fastener 70 is preferably made of an electrically conductive material, such as an electrically conductive metal. Non-limiting examples of electrically conductive metals include copper, aluminum, aluminum alloys, stainless steel and brass. However, the present disclosure contemplates that other electrically conductive materials may be used to fabricate the fastener 70. Non-limiting examples of other electrically conductive materials include graphite and conductive polymers. For ease of description, the one or more fasteners 70 may also be referred to herein as the “pins” in the plural and the “pin” in the singular. The fastener 70 includes a fastener body 72 having a first end portion 74 and a second end portion 76. In the exemplary embodiment shown, fastener 70 may have a cylindrical shape so that the shape of the fastener 70 corresponds to the shape of the fastener bore 30. However, the fastener body 72 may have any shape capable of being received in the fastener bore 30 so that the pressure member 40 can be secured within the opening 32 of the connector body 20. Non-limiting examples of other shapes for the fastener 70 include elliptical, triangular and rectangular. Fastener 70 may be a solid member, a hollow member or a partially hollow member. In the embodiment shown, the fastener 70, which may be a pin, is a solid member.

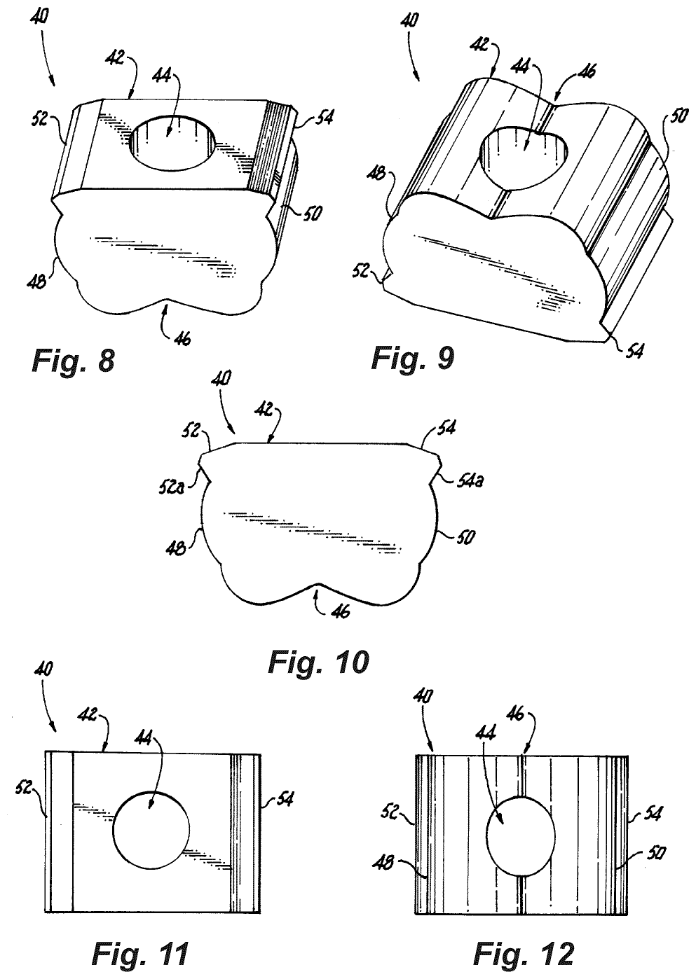

Referring now to FIGS. 8-12, an exemplary embodiment of the pressure member 40 is shown. The pressure member 40 includes a body 42 having a fastener bore 44 extending therethrough. The body 42 includes an alignment notch 46, a first pressure boss 48, a second pressure boss 50, a first locking boss 52 and a second locking boss 54. The alignment notch 46 is configured and dimensioned to receive the raised edge 28, seen in FIGS. 4 and 6, of the central portion 22 of the connector body 20 so that the pressure member 40 can rest on the raised edge 28 when attached to the connector body 20. The raised edge 28 and alignment notch 46 facilitate aligning the pressure member 40 within the connector body 20 when the pressure member 40 is installed in the connector body 20. In addition, the alignment notch 46 also helps maintain the pressure member 40 in position within the opening 32 of the connector body 20 when hammering or pressing the pressure member 40 to the connector body. The first pressure boss 48 extends from a side wall of the body 42, and preferably from a central portion of the side wall. The first pressure boss 48 is configured and dimensioned to contact the conductor 500 and to apply a compressive force to the conductor causing the conductor 500 to move against the one or more inner walls 24b of the first end portion 24 of the connector body 20 with a force sufficient to clamp the conductor 500 within the connector body 20. The second pressure boss 50 extends from a side wall of the body 42 that is opposite the side with the first pressure boss 48, and preferably from a central portion of the side wall. The second pressure boss 50 is configured and dimensioned to contact the conductor 502 and to apply a compressive force to the conductor causing the conductor 502 to move against the one or more inner walls 26b of the second end portion 26 of the connector body 20 with a force sufficient to clamp the conductor 502 within the connector body 20.

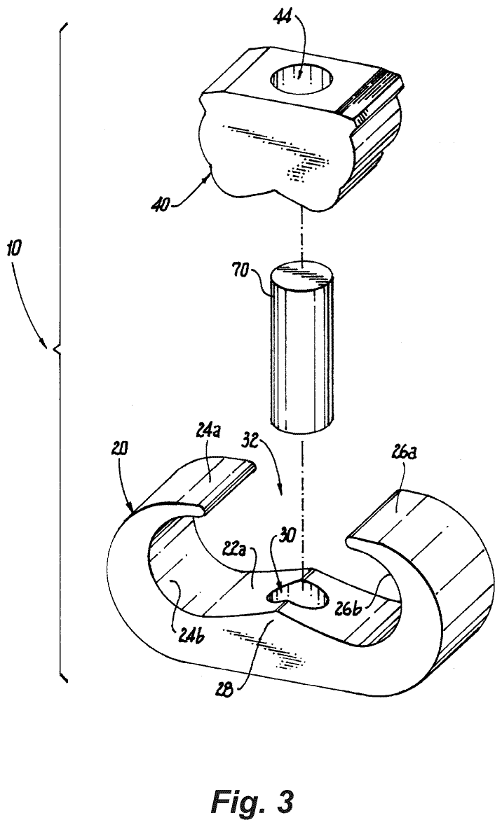

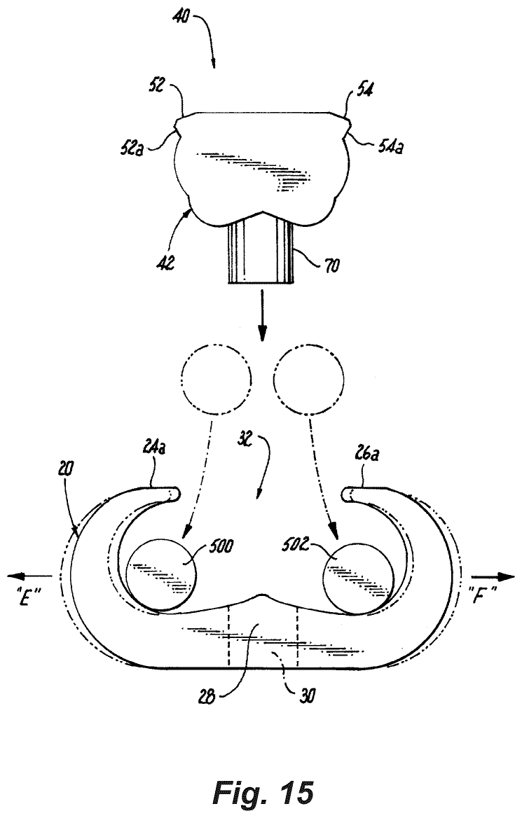

Continuing to refer to FIGS. 8-12, the first locking boss 52 extends from the same side wall of the body 42 as the first pressure boss 48, and preferably from an upper portion of the side wall. The first locking boss 52 includes a camming surface 52a, seen in FIG. 10, and extends from the body 42 a sufficient distance to extend beyond the free end 24a of first end portion 24 of the connector body 20. Similarly, the second locking boss 54 extends from the same side wall of the body 42 as the second pressure boss 50, and preferably from an upper portion of the side wall. The second locking boss 54 includes a camming surface 54a, seen in FIG. 10, and extends from the body 42 a sufficient distance to extend beyond the free end 26a of second end portion 26 of the connector body 20. In other words, the locking bosses 52 and 54 render the upper portion of the body 42 wider than the size of the opening 32, seen in FIGS. 4 and 6, in the connector body 20. As a result, when the pressure member 40 is inserted into the opening 32 of the connector body 20, the camming surface 52a causes the free end 24a to flex outwardly in the direction of arrow “E,” shown in FIG. 15, and the camming surface 54a causes the free end 26a to flex outwardly in the direction of arrow “F,” shown in FIG. 15. Flexing the free ends 24a and 26a outwardly creates a second width in the connector body opening 32 that is preferably greater than the first width when the free ends 24a 26a are in their normal resting position, shown in FIGS. 3-6. Flexing the free ends 24a and 26a permits the first locking boss 52 and the second locking boss 54 to pass into the opening 32 so that the pressure member 40 is within the opening 32 of the connector body 20. Once the first locking boss 52 and the second locking boss 54 pass into the opening 32, the free ends 24a and 26a return, e.g., spring back or otherwise automatically return, to their normal resting position, which is a locking position. In the locking position, the free end 24a of the first end portion 24 and the free end 26a of the second end portion 26 engage the first locking boss 54 and the second locking boss 54 which blocks the removal of the pressure member 40 from the opening 32 in the connector body 20.

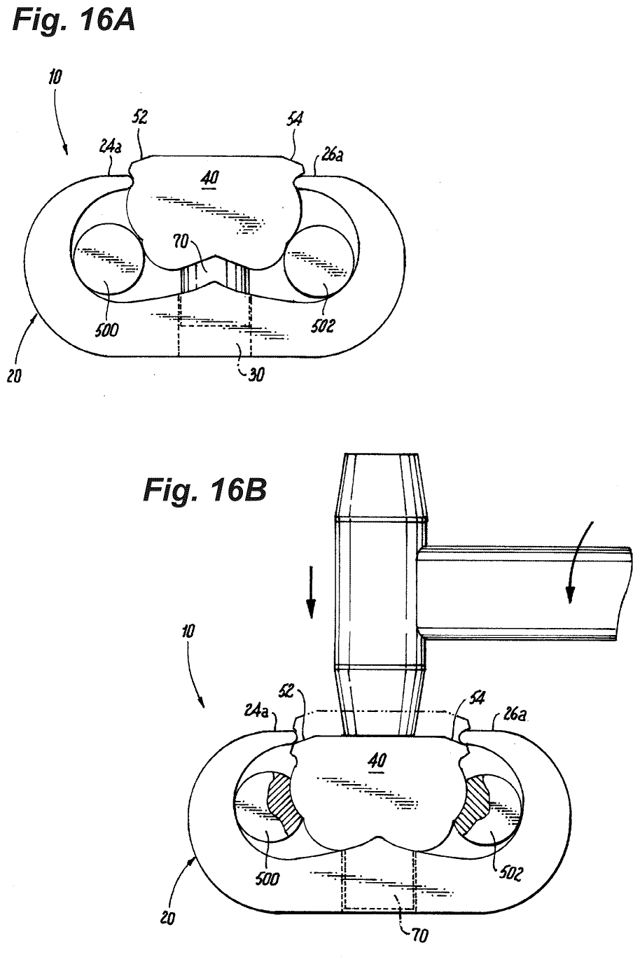

Referring now to FIGS. 15-18, an exemplary description for securing the conductors 500 and 502 to the connector assembly 10 is provided. In this exemplary embodiment, the pressure member 40 and the fastener 70 are removed from the connector body 20 so that conductors 500 and 502 can be inserted into the opening 32 in the connector body 20, seen in FIG. 15. A technician then inserts the portion of fastener 70 extending from the pressure member 40 into the fastener bore 30 in the connector body 20 until the first and second locking bosses 52 and 54 rest on the respective free ends 24a and 26a of the connector body 20, seen in FIG. 16A. The technician then impacts the top surface of the body 42 with a hammer or other suitable tool causing the fastener 70 to move within the fastener bore 30 until the raised edge 28 of the central portion 22 of the connector body 20 rests within the alignment notch 46 in the body 42 of the pressure member 40, as shown in FIGS. 16A and 16B. As the technician is hammering the top surface of the body 42, the camming surfaces 52a and 54a cause the free ends 24a and 26a of the connector body 20 to flex outwardly so that the connector body opening 32 is at a second width, as described above and shown in FIGS. 15 and 16A permitting the first and second locking bosses 52 and 54 to pass into the opening 32 in the connector body 20. Once the first and second locking bosses 52 and 54 pass into the opening 32, the free ends 24a and 26a return, e.g., spring back or otherwise automatically return, to their normal resting position, blocking the removal of the pressure member 40 from the opening 32 in the connector body 20, as shown in FIG. 16B. When the free ends 24a and 26a return to their normal resting position, the pressure member 40 is held, clamped, attached or otherwise secured to the connector body 20. With the pressure member 40 secured to the connector body 20, the first and second pressure bosses 48 and 50 apply a force or pressure to the conductors 500 and 502 wedging the conductors 500 and 502 against an inner wall of the first and second end portions of the connector body 20 so as to hold, clamp, attach or otherwise secure the conductors 500 and 502 to the connector assembly 10. In some embodiments, the first and second pressure bosses 48 and 50 contact the conductors 500 and 502 without deforming the conductors to hold, clamp, attach or otherwise secure the conductors 500 and 502 to the connector assembly 10, as shown in FIG. 14. In some embodiments, the first and second pressure bosses 48 and 50 contact the conductors 500 and 502 and slightly deforming, e.g., indent, the conductors to hold, clamp, attach or otherwise secure the conductors 500 and 502 to the connector assembly 10, as shown in FIG. 16B.

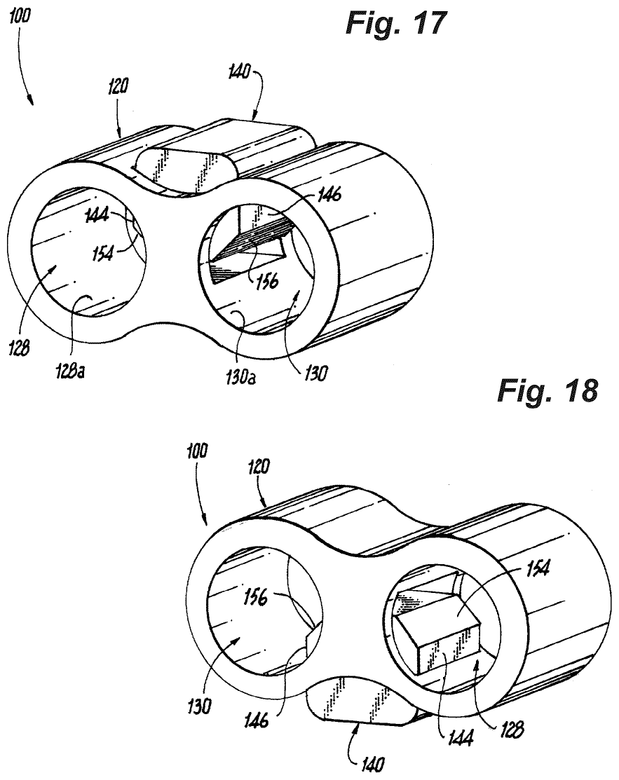

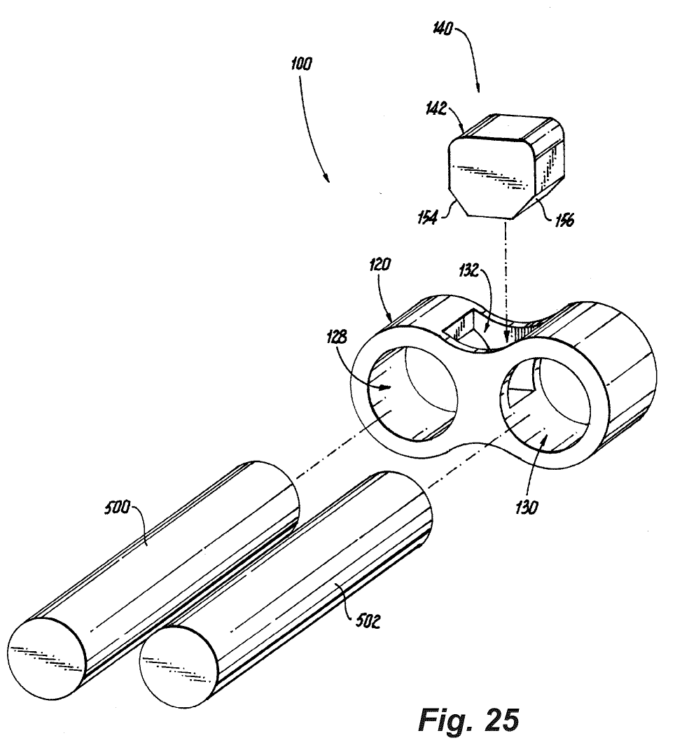

Referring now to FIGS. 17-19, another exemplary embodiment of an electrical conductor connector assembly according to the present disclosure is shown. In this exemplary embodiment, the connector 100 includes a connector body 120 and at least one pressure member 140. The connector body 120 may also be referred to herein as the “body.” The connector 100 may be configured and dimensioned to electrically connect two or more electrical conductors 500 or 502, seen in FIG. 25, such that the two or more electrical conductors 500 and 502 are in electrical communication. The size of the conductors 500 and 502 may vary depending upon the intended purpose of the conductors and requirements set forth in industry standards and/or regulations. The two or more conductors 500 and 502 may be the same size or the conductors may be different in size. To illustrate, in one embodiment, the conductors 500 and 502 may be the same size, such as a #6 AWG conductor, or in another embodiment where the conductors 500 and 502 may be the different size conductors, such as a #6 AWG conductor 500 and a #2 AWG conductor 502.

Continuing to refer to FIGS. 17-20, the connector body 120 may be a substantially rectangular shaped member, although other shapes may be used to electrically connect two or more electrical conductors 500 and 502 together. Non-limiting examples of other shapes of the connector body 20 include cylindrical, conical and frustoconical shapes. The connector body 120 is preferably made of an electrically conductive material, such as an electrically conductive metal. Non-limiting examples of electrically conductive metals include copper, aluminum, aluminum alloys, stainless steel and brass. However, the present disclosure contemplates that other electrically conductive materials may be used to fabricate the connector body 120. Non-limiting examples of other electrically conductive materials include graphite and conductive polymers.

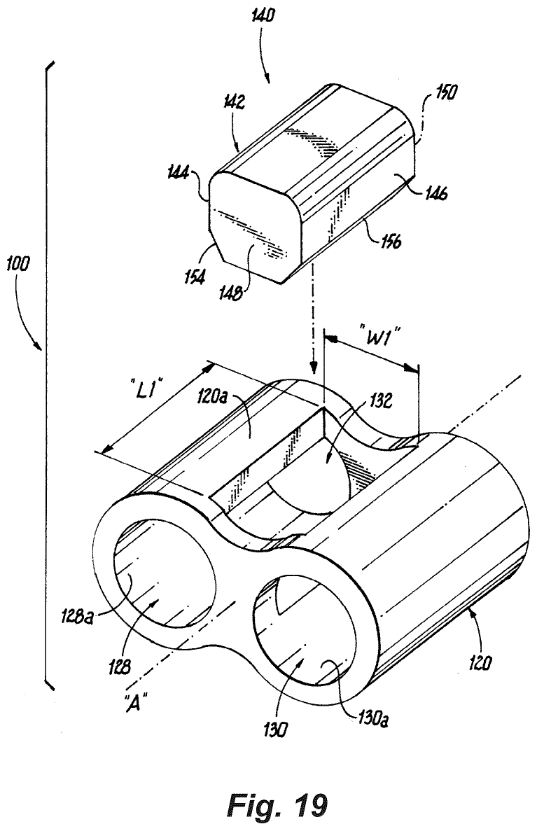

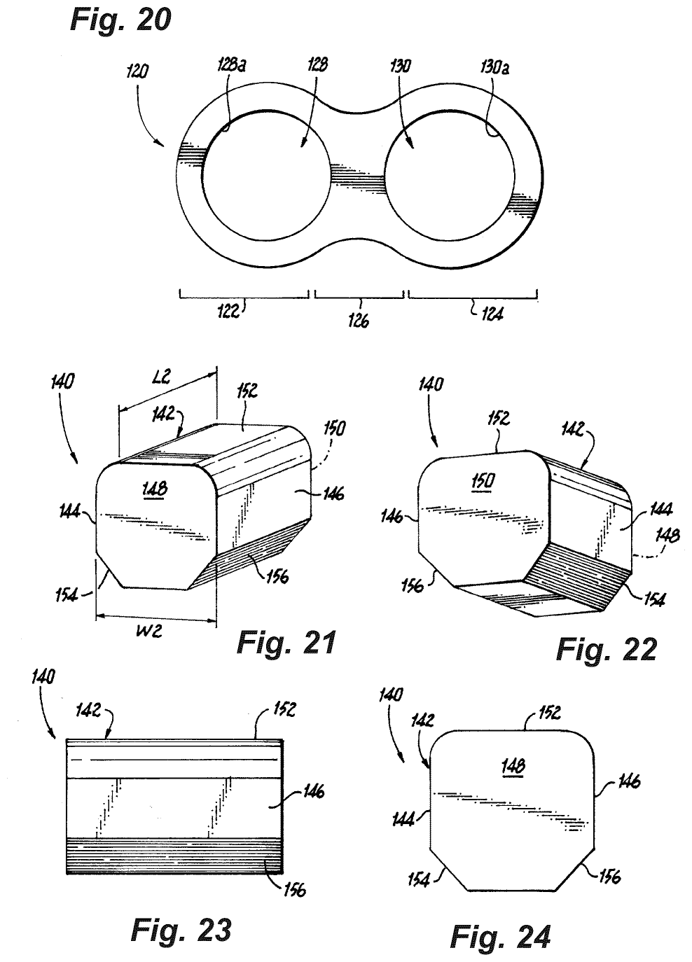

In the exemplary embodiment shown, the connector body 120 has a first conductor portion 122, a second conductor portion 124, and a central portion 126 between the first conductor portion 122 and the second conductor portion 124, as shown in FIG. 20. The first conductor portion 122 of the connector body 120 includes a conductor aperture, bore or opening 128 extending through the connector body 120 that is configured and dimensioned to receive a conductor 500, as shown in FIG. 25. For ease of description, the conductor aperture, bore or opening 128 may also be referred to herein as the “conductor aperture 128” or the “aperture 128.” The second conductor portion 124 of the connector body 120 includes a conductor aperture, bore or opening 130 extending through the connector body 120 that is configured and dimensioned to receive a conductor 502, as shown in FIG. 25. For ease of description, the conductor aperture, bore or opening 130 may also be referred to herein as the “conductor aperture 130” or the “aperture 130.” The apertures 128 and 130 are preferably substantially cylindrical openings extending through the connector body 20 substantially parallel to the longitudinal axis “A” of the connector body 120, seen in FIG. 19. The diameter of the apertures 128 and 130 are configured to receive the conductor 500 or 502 the aperture is designed to receive. To illustrate, in one embodiment where the conductors 500 and 502 are the same size, such as a #6 AWG conductor, the diameters of the apertures 128 and 130 would be sized to receive the #6 AWG conductor. In another embodiment, where the conductors 500 and 502 may be different size conductors, such as a #6 AWG conductor 500 and a #2 AWG conductor 502, the diameter of aperture 128 may be sized to receive the #6 AWG conductor 500 and the diameter of aperture 130 may be sized to receive the #2 AWG conductor 502.

Continuing to refer to FIGS. 17-20, the connector body 120 also includes at least one pressure member opening, bore or aperture 132 extending from an exterior surface 120a of the connector body 120 into the connector body 120 a depth at least as far as to intersect with the apertures 128 and 130, as shown in FIG. 19. For ease of description, the pressure member opening, bore or aperture 132 may also be referred to herein as the “pressure member opening 132” or the “opening 132.” The pressure member opening 132 is configured and dimensioned to receive the at least one pressure member 140 so that the at least one pressure member 140 can secure, e.g., clamp, the conductor 500 within aperture 128 and the conductor 502 within the aperture 130. In the embodiment shown, the at least one pressure member opening 132 is a substantially rectangular shaped opening having a width “W1” and a length “L1”. The width “W1” and length “L1” of the pressure member opening 132 is configured and dimensioned to receive the pressure member 140 and to secure the pressure member 140 within the connector body 120 with an interference fit, e.g., a friction fit or a press fit connection.

Referring now to FIGS. 21-24, an exemplary embodiment of the pressure member 140 is shown. The pressure member 140 includes a body 142 has width “W2” between a first side wall 144 and a second side wall 146, and a length “L2” between a first end wall 148 and a second end wall 150. A top surface 152 of the pressure member 140 forms an impacting surface used when hammering or pressing the pressure member into the opening 132 in the connector body 120. The width “W2” of the pressure member 140 is larger than the width “W1” of the opening 132 in the connector body 120, and the length “L2” of the pressure member 140 is larger than the length “L1” of the opening 132, seen in FIG. 19, in the connector body 120. Having the dimensions of the pressure member 140 larger than the dimensions of the dimensions of the opening 132 creates the interference fit, e.g., a friction fit or a press fit connection, between the pressure member 140 and the connector body 120. The pressure member 140 also includes a first contact surface 154 and a second contact surface 156. The contact surfaces 154 and 156 act as lead-in's guiding the pressure member 140 into the opening 132. When the pressure member 140 is hammered or pressed into the opening 132, the first contact surface 154 applies a compressive force to the conductor 500 causing the conductor to move against the inner wall 128a of the aperture 128 of the connector body 20 with a force sufficient to clamp the conductor 500 within the connector body 20. Similarly, when the pressure member 140 is hammered or pressed into the opening 132, the second contact surface 156 applies a compressive force to the conductor 502 causing the conductor to move against the inner wall 130a of the aperture 130 of the connector body 20 with a force sufficient to clamp the conductor 502 within the connector body 20.

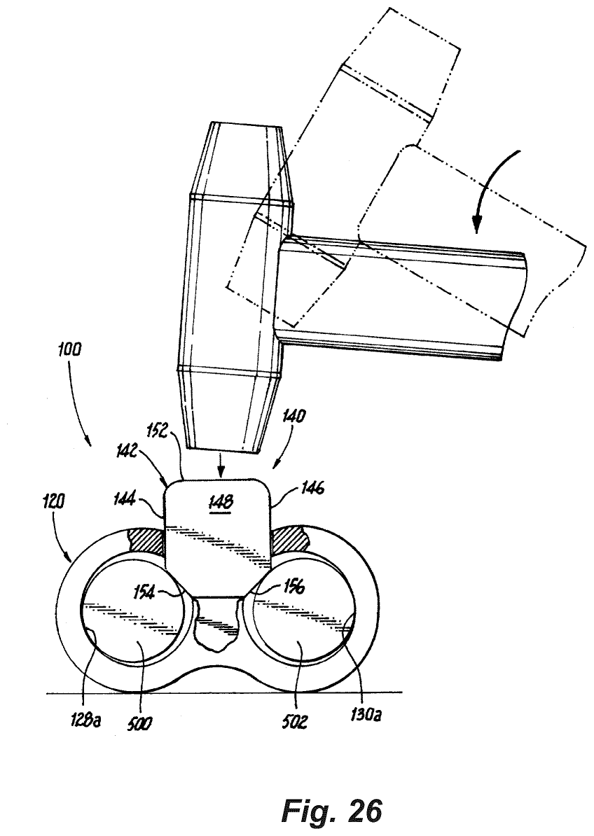

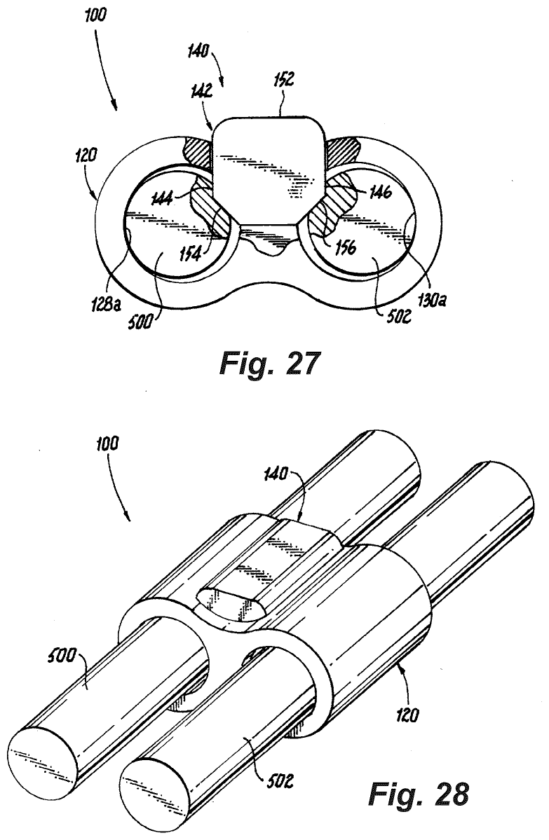

Referring now to FIGS. 25-28, an exemplary description for securing the conductors 500 and 502 to the connector assembly 100 is provided. In this exemplary embodiment, the conductors 500 and 502 and the pressure member 140 are initially staged for insertion into the connector body 120, as shown in FIG. 25. The pressure member 140 is then inserted into the opening 132 of the connector body 120 such that the pressure member 140 is in an open position where conductors 500 and 502 can be inserted into the respective conductor apertures 128 and 130, as shown in FIG. 26. The conductors 500 and 502 are then inserted into the respective conductor apertures 128 and 130 in the connector body 120. A technician then impacts the impacting surface 152 of the pressure member 140 with a hammer or other suitable tool causing the pressure member 140 to move within the opening 132 until the contact surfaces 154 and 156 of the pressure member 140 apply sufficient force on the respective conductors 500 or 502 to wedge and possibly indent the conductors 500 and 502 to secure or clamp the conductors within the respective conductor apertures 128 or 130 of the connector body 120. As the pressure member 140 moves within the opening 132, friction between the walls 144, 146, 148 and 150 of the pressure member 140 and the walls of the opening 132 increases sufficiently to form an interference fit, e.g., a friction fit or press fit connection, between the connector body 120 and the pressure member 140 to irreversibly or permanently connect or join the electrical conductors 500 and 502 together as shown in FIGS. 27 and 28.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered as illustrative and not restrictive, and the body of work described herein is not to be limited to the details given herein, which may be modified within the scope and equivalents of the appended claims.

What is claimed is:

1. A connector assembly comprising:
a connector body having a central portion between a first end portion and a second end portion, the central portion including at least one fastener bore, the first end portion includes an inner wall configured to receive a first conductor and a free end, and the second end portion includes an inner wall configured to receive a second conductor and a free end, wherein the free end of the first end portion and the free end of the second end portion are spaced apart forming an opening in the connector body having a first width;
a pressure member having a body with at least one fastener bore extending therethrough, the pressure member having a first pressure boss and a second pressure boss, the first pressure boss being configured to contact and hold the first conductor within the first end portion when the pressure member is installed in the connector body, the second pressure boss being configured to contact and hold the second conductor within the second end portion when the pressure member is installed in the connector body, the pressure member body having a width along the body that is larger than the first width of the connector body opening;
at least one fastener configured to fit within the at least one fastener bore of the central portion by an interference fit and the at least one fastener bore in the pressure member by an interference fit.

2. The connector assembly according to claim 1, wherein the first end portion and the second end portion of the connector body are C-shaped members.

3. The connector assembly according to claim 1, wherein the central portion of the connector body includes a raised edge and the pressure member body includes an alignment notch configured to receive the raised edge.

4. The connector assembly according to claim 1, wherein the at least one fastener bore is a circular bore and the at least one fastener is a cylindrical member such that the cylindrical member fits within the fastener bore with the interference fit.

5. The connector assembly according to claim 1, wherein the pressure member includes a first locking boss and a second locking boss, wherein the first and second locking bosses extend from the pressure member so as to increase a width of at least a portion of the pressure member such that the width of the at least a portion of the pressure member is greater than the first width of the opening in the connector body.

6. The connector assembly according to claim 1, wherein the pressure member includes a first locking boss having a camming surface that contacts the free end of the first end portion of the connector body when the pressure member is installed in the connector body, wherein the pressure member includes a second locking boss having a camming surface that contacts the free end of the second end portion of the connector body, and wherein when the camming surfaces contact the free ends of the first and second end portions, the first and second end portions of the connector body flex so as to increase the opening in the connector body to a second width.

7. The connector assembly according to claim 6, wherein when the camming surfaces no longer contact the free ends of the first and second end portions the opening in the connector body returns to the first width.

8. The connector assembly according to claim 1, wherein when the first pressure boss contacts and holds the first conductor within the first end portion, the first pressure boss deforms the first conductor, and wherein when the second pressure boss contacts and holds the second conductor within the second end portion, the second pressure boss deforms the second conductor.

9. A connector assembly comprising:
a connector body having a central portion between a first end portion and a second end portion, the central portion including a fastener bore, the first end portion includes an inner C-shaped wall configured to receive a first conductor and a free end, and the second end portion includes an inner C-shaped wall configured to receive a second conductor and a free end, wherein the free end of the first end portion and the free end of the second end portion are spaced apart forming an opening in the connector body having a first width;
a pressure member that includes:
a body having a width along an upper portion of the body that is larger than the first width of the connector body opening and a fastener bore extending therethrough that is aligned to interact with the fastener bore in the central portion;
a first pressure boss configured to contact and hold the first conductor within the first end portion when the pressure member is installed in the connector body; and
a second pressure boss configured to contact and hold the second conductor within the second end portion when the pressure member is installed in the connector body; and
a fastener configured to fit within the fastener bore of the central portion and the fastener bore in the pressure member by an interference fit.

10. The connector assembly according to claim 9, wherein the central portion of the connector body includes a raised edge and the pressure member body includes an alignment notch configured to receive the raised edge.

11. The connector assembly according to claim 9, wherein the fastener bore is a circular bore and the fastener is a cylindrical member such that the cylindrical member fits within the fastener bore with the interference fit.

12. The connector assembly according to claim 9, wherein the pressure member includes a first locking boss and a second locking boss, wherein the first and second locking bosses extend from the pressure member so as to increase a width of at least a portion of the pressure member such that the width of the at least a portion of the pressure member is greater than a width of the opening in the connector body.

13. The connector assembly according to claim 9, wherein the pressure member includes a first locking boss having a camming surface that contacts the free end of the first end portion of the connector body when the pressure member is installed in the connector body, wherein the pressure member includes a second locking boss having a camming surface that contacts the free end of the second end portion of the connector body, and wherein when the camming surfaces contact the free ends of the first and second end portions, the first and second end portions of the connector body flex so as to increase the opening in the connector body to a second width.

14. The connector assembly according to claim 13, wherein when the camming surfaces no longer contact the free ends of the first and second end portions the opening in the connector body returns to the first width.

15. The connector assembly according to claim 9, wherein when the first pressure boss contacts and holds the first conductor within the first end portion, the first pressure boss deforms the first conductor, and wherein when the second pressure boss contacts and holds the second conductor within the second end portion, the second pressure boss deforms the second conductor.

16. A connector assembly comprising:
a connector body having first and second conductor apertures and at least one pressure member opening, the first and second conductor apertures extend through the connector body and the at least one pressure member opening extends from an exterior of the connector body into the connector body such that the at least one pressure member opening at least partially intersects the first and second conductor apertures; and
at least one pressure member configured to fit within the at least one pressure member opening by an interference fit, the at least one pressure member includes:
a first contact surface configured to contact and hold a first conductor positioned within the first conductor aperture when the at least one pressure member is installed in the at least one pressure member opening, and
the second contact surface configured to contact and hold a second conductor positioned within the second conductor aperture when the at least one pressure member is installed in the at least one pressure member opening.

17. The connector assembly according to claim 16, wherein at least one pressure member includes an impacting surface.

18. The connector assembly according to claim 17, wherein the impacting surface is a substantially flat surface.

19. The connector assembly according to claim 9, wherein when the first contact surface contacts and holds the first conductor within the first conductor aperture by applying a force on the first conductor such that the first conductor is wedged against an inner wall of the first conductor aperture, and when the second contact surface contacts and holds the second conductor within the second conductor aperture by applying a force on the second conductor such that the second conductor is wedged against an inner wall of the second conductor aperture.

20. The connector assembly according to claim 9, wherein when the first contact surface contacts and holds the first conductor within the first conductor aperture by applying a force on the first conductor deforming the first conductor so that the first conductor is wedged against an inner wall of the first conductor aperture, and when the second contact surface contacts and holds the second conductor within the second conductor aperture by applying a force on the second conductor deforming the second conductor so that the second conductor is wedged against an inner wall of the second conductor aperture.
